(19) United States
(12) Patent Application Publication
(10) Pub. No.: US 2011/0055291 A1
(43) Pub. Date: Mar. 3, 2011

(54) Database Integration Tool

(76) Inventors: Bryn Henderson, Cumming, GA (US); Walter G. Bullard, Marietta, GA (US); Lynn D. Larrow, Lafayette, CA (US)

(21) Appl. No.: 12/551,099

(22) Filed: Aug. 31, 2009

(51) Int. Cl. G06F 7/14; G06F 17/30

(52) U.S. Cl. 707/808; 707/E17.006; 707/E17.032

(57) ABSTRACT

A first data set is gathered from a first server computer, and second data set is gathered from a second server computer. The first server computer may include a first database storing first aspects of subscriber data and a first interface configured to access the first database. The second server computer may include a second database storing second aspects of subscriber data and a second interface configured to access the second database. The first data set and the second data set are transformed into an integrated data set by merging the first data set and the second data set into the integrated data set. A central interface configured to access the integrated data set and bypass the first interface and the second interface is provided. The central interface may be configured to concurrently display the first aspects of subscriber data and the second aspects of subscriber data through a computer.

### BACKGROUND

This application relates generally to the field of database integration. More specifically, the disclosure provided herein relates to merging data from multiple databases and displaying the data in a manner conducive to comparing the data between the databases.

Entities may store a variety of information across multiple databases. Each database may include its own interface, such as a graphical user interface (“GUI”), for accessing the information in the database. A challenge may arise when a user needs to concurrently view the information across two or more databases. For example, the user may want to compare information across the databases. In this case, the user may open a separate window for each GUI corresponding to the databases. The user may then traverse between multiple GUIs in order to view and compare the information. This approach is suboptimal as the user may be required to move, minimize, and/or close windows, thereby increasing the difficulty for viewing and comparing the information across the databases.

### SUMMARY

Embodiments of the disclosure presented herein include methods, systems, and computer-readable media for displaying data from multiple server computers. According to one aspect, a method for displaying data from multiple server computers is provided. According to the method, a first data set is gathered from a first server computer from the multiple server computers. The first server computer may include a first database storing first aspects of subscriber data and a first interface configured to access the first database. A second data set is gathered from a second server computer from the multiple server computers. The second server computer may include a second database storing second aspects of subscriber data and a second interface configured to access the second database. The first data set from the first server computer and the second data set from the second server computer are transformed into an integrated data set by merging the first data set and the second data set into the integrated data set. A central interface configured to access the integrated data set and bypass the first interface and the second interface is provided. The central interface may be configured to concurrently display the first aspects of subscriber data and the second aspects of subscriber data through a computer.

According to another aspect, a system for displaying data from multiple server computers is provided. The system includes a memory and a processor functionally coupled to the memory. The memory stores a program containing code for displaying data from multiple server computers. The processor is responsive to computer-executable instructions contained in the program and configured to perform the following operations. A first data set is gathered from a first server computer from the multiple server computers. The first server computer may include a first database storing first aspects of subscriber data and a first interface configured to access the first database. A second data set is gathered from a second server computer from the multiple server computers. The second server computer may include a second database storing second aspects of subscriber data and a second interface configured to access the second database. The first data set from the first server computer and the second data set from the second server computer are transformed into an integrated data set by merging the first data set and the second data set into the integrated data set. A central interface configured to access the integrated data set and bypass the first interface and the second interface is provided. The central interface may be configured to concurrently display the first aspects of subscriber data and the second aspects of subscriber data through a computer.

According to yet another aspect, a computer-readable medium having instructions stored thereon for execution by a processor to perform a method for displaying data from multiple server computers is provided. According to the method, a first data set is gathered from a first server computer from the multiple server computers. The first server computer may include a first database storing first aspects of subscriber data and a first interface configured to access the first database. A second data set is gathered from a second server computer from the multiple server computers. The second server computer may include a second database storing second aspects of subscriber data and a second interface configured to access the second database. The first data set from the first server computer and the second data set from the second server computer are transformed into an integrated data set by merging the first data set and the second data set into the integrated data set. A central interface configured to access the integrated data set and bypass the first interface and the second interface is provided. The central interface may be configured to concurrently display the first aspects of subscriber data and the second aspects of subscriber data through a computer.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a simplified diagram illustrating an exemplary network architecture configured to generate and display an integrated data set, in accordance with some embodiments.

FIG. 2 is a block diagram illustrating an exemplary configuration of a data interface, in accordance with some embodiments.

FIG. 3 is a diagram illustrating an exemplary graphical representation of an integrated data set as displayed through a data interface, in accordance with some embodiments.

FIG. 4 is a flow diagram illustrating an exemplary method for generating and displaying an integrated data set, in accordance with some embodiments.

FIG. 5 is a block diagram illustrating an exemplary computer system configured to generate and display and integrated data set, in accordance with some embodiments.

### DETAILED DESCRIPTION

The following detailed description is directed to methods, systems, and computer-readable media for generating and displaying an integrated data set. In some instances, legacy databases may be tied to a dedicated interface configured to access only one particular database and no other databases. In this case, when a user desires to compare data between multiple databases, the user may be required to open separate dedicated interfaces, each of which accesses and displays a different database. In order to compare data between the databases, the user may also be required to maximize/minimize interfaces or otherwise traverse between the interfaces. Such an approach is suboptimal for comparing data between the databases because all of the data may not be concurrently displayed, potentially causing significant frustration for the user.

Embodiments described herein provide a database integration tool configured to gather the data sets from the multiple databases and to transform the data sets into an integrated data set. A central interface is then provided for accessing and displaying the integrated data set. In particular, the central interface may be configured to concurrently display data across multiple databases. In this manner, a user can view the data across multiple databases through a single interface, which is more conducive to comparing data between the databases than opening multiple interfaces.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

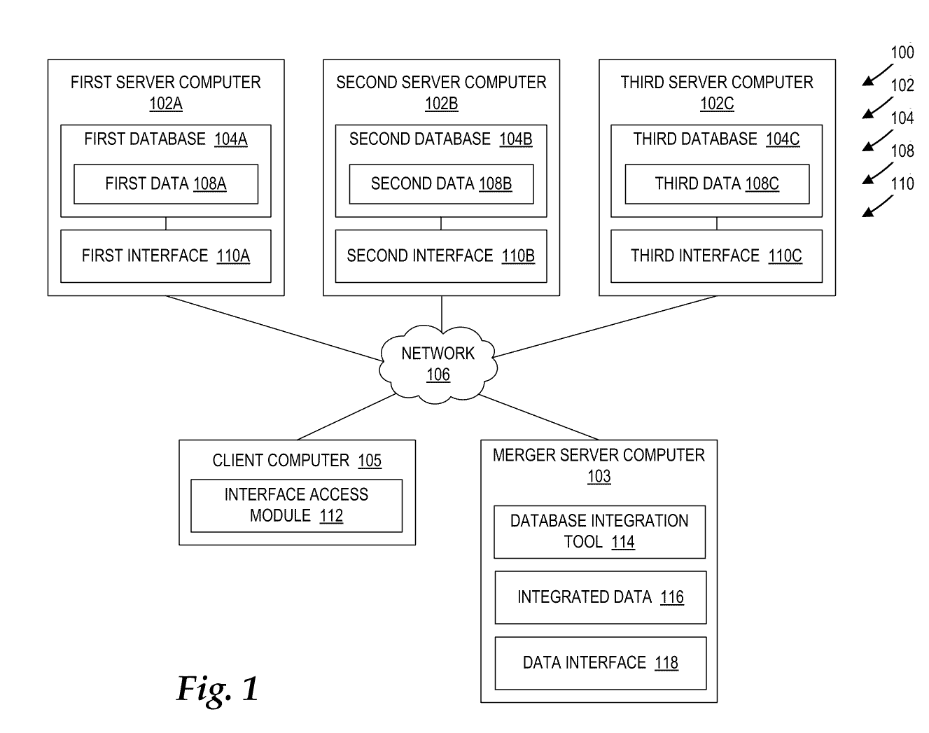

In the following detailed description, references are made to the accompanying drawings that form a part hereof, and which are shown by way of illustration, specific embodiments, or examples. Referring now to the drawings, in which like numerals represent like elements through the several figures, a computing system and methodology for displaying data from multiple databases will be described. In particular, FIG. 1 is an exemplary simplified network architecture 100 configured to transform data from multiple databases into an integrated data set and to display the integrated data set through a single interface, according to some embodiments. The network architecture 100 includes a first server computer 102A, a second server computer 102B, a third server computer 102C, a merger server computer 103, and a client computer 105, each of which is coupled to a network 106, such as a local area network (“LAN”) or the Internet.

As illustrated in FIG. 1, the first server computer 102A includes a first database 104A and a first interface 110A. The first database 104A includes a first data set 108A. The second server computer 102B includes a second database 104B and a second interface 110B. The second database 104B includes a second data set 108B. The third server computer 102C includes a third database 104C and a third interface 110C. The third database 104C includes a third data set 108C. The first server computer 102A, the second server computer 102B, and the third server computer 102C may be collectively referred to as server computers 102. The first database 104A, the second database 104B, and the third database 104C may be collectively referred to as databases 104. The first data set 108A, the second data set 108B, and the third data set 108C may be collectively referred to as data sets 108. The first interface 110A, the second interface 110B, and the third interface 110C may be collectively referred to as interfaces 110.

According to embodiments, the interfaces 110 are configured to access and display the data sets 108 from the corresponding databases 104. For example, the first interface 110A may be configured to access and display the first data set 108A, and the second interface 110B may be configured to access and display the second data set 108B. Further, the third interface 110C may be configured to access and display the third data set 108C.

In some embodiments, each of the data sets 108 can be accessed and displayed only by a corresponding one of the interfaces 110. Thus, the first data set 108A may be accessed only by the first interface 110A and not by the second interface 110B or the third interface 110C, and the second data set 108B may be accessed only by the second interface 110B and not by the first interface 110A or the third interface 110C. Further, the third data set 108C may be accessed only by the third interface 110C and not by the first interface 110A or the second interface 110B.

In one embodiment, the server computers 102 are part of a digital subscriber line (“DSL”) provisioning system. When a customer orders DSL from a provider, an ordering system typically sends a provisioning request to all relevant equipment (hereinafter referred to as DSL equipment) on the DSL network to activate DSL for the customer. This is commonly referred to as provisioning the customer or provisioning a subscription for the customer. Each of the server computers 102 may be responsible for a different task within the DSL provisioning system, and each of the databases 104 may store different data sets 108 associated with those tasks. At least a portion of the data sets 108 may include data from the DSL network, such as DSL equipment data. Examples of equipment on the DSL network may include a digital subscriber line access multiplexer (“DSLAM”), a broadband remote access server (“BRAS”), an element management system (“EMS”), and the like. Each DSL subscription is typically associated with a unique identifier, such as a subscriber's telephone number.

Also as illustrated in FIG. 1, the client computer 105 includes an interface access module 112, and the merger server computer 103 includes a database integration tool 114, an integrated data set 116, and a data interface 118, according to some embodiments. In conventional implementations, a user may utilize the interface access module 112 to access each of the interfaces 110 via the network 106. In one embodiment, the interface access module 112 is a web browser, and the interfaces 110 are web pages. In this case, each of the interfaces 110 may be associated with a unique uniform resource locator (“URL”). Users may enter the URLs into the interface access module 112 to access the corresponding interfaces 110.

A drawback with the conventional implementations is the limitation of the interfaces 110. As previously described, in some implementations, each of the data sets 108 may be accessed only by a corresponding one of the interfaces 110. In this case, difficulty may arise when a user wants to concurrently view two or more of the data sets 108. For example, if a user wants to visually compare the first data set 108A and second data set 108B, the user may be required to open two instances of the interface to access module 112. The first instance of the interface access module 112 may access the first interface 110A to view the first data set 108A, while the second instance of the interface access module 112 may access the second interface 110B to view the second data set 108B.

In order to compare the first data set 108A and the second data set 108B, the user may attempt to open both the first interface 110A and the second interface 110B on the same display. However, if the data sets 108A, 108B are too large or if the interfaces 110A, 110B limit or restrict the concurrent viewing of multiple interfaces, the user may only be able to view one of the interfaces 110A, 110B at a given time. In this case, the user may need to traverse between the interfaces 110A, 110B by maximizing/minimizing windows or by utilizing the Alt-Tab command in MICROSOFT WINDOWS. This may cause significant frustration to the user if the user prefers a same-screen or side-by-side display of the interfaces.

According to embodiments, the database integration tool 114 and the data interface 118 address the above and other drawbacks of the interfaces 110. In particular, the database integration tool 114 may gather the first data set 108A from the first database 104A, the second data set 108B from the second database 104B, and the third data set 108C from the third database 104C. The database integration tool 114 may utilize any suitable database commands in order to retrieve the data sets 108 from the databases 104. The database integration tool 114 may then transform the data sets 108 into the integrated data set 116 by merging the data sets 108 into the integrated data set 116. The data interface 118 may be utilized to access and view the integrated data set 116. In particular, a user may utilize the interface access module 112 to access the data interface 118 via the network 106.

According to embodiments, each value retrieved from the databases 104 may be associated with an identifier. The identifier may include any suitable combination of alphanumeric characters, for example. The identifier may enable the database integration tool 114 to associate the information retrieved from the databases 104 to a particular network data element. In at least some instances, these identifiers may be a unique identifier that may differ between different databases. Thus, a problem may arise when different identifiers refer to the same data. For example, one database may refer to a Asynchronous Transfer Mode Virtual Path Identifier (“ATM VPI”) on a DSLAM Network Termination (“NT”) card as “trunk_vp”, while another database may refer to the ATM VPI on the DSLAM NT as “dslamvpi”. In order to resolve the different identifiers, the database integration tool 114 may be configured to map both “trunk_vp” and “dslamvpi” values to the same network data element (i.e., the ATM VPI on the DSLAM NT). In this way, the data interface 118 may properly display the values of “trunk_vp” and “dslamvpi” as being associated with the same network data element.

In some embodiments, the integrated data set 116 may include various aspects of subscriber data gathered from the server computers 102 within the DSL provisioning system. In further embodiments, the integrated data set 116 may also include a conversion data set and a fallout data set. The conversion data set and the fallout data set may be generated during a conversion process whereby subscriber data from multiple previous databases are utilized to seed a new database. In particular, the conversion data set may include a listing of those subscribers whose subscriber data matches across the multiple previous databases. The fallout data set may include of those subscribers whose subscriber data does not match across the multiple previous databases. When the subscriber data does not match, a synchronization problem occurs that may affect the provisioning process. By merging both the conversion data set and the fallout data set within the integrated data set 116, a user can access the integrated data set 116 via the data interface 118 in order to troubleshoot any synchronization problems in the provisioning process.

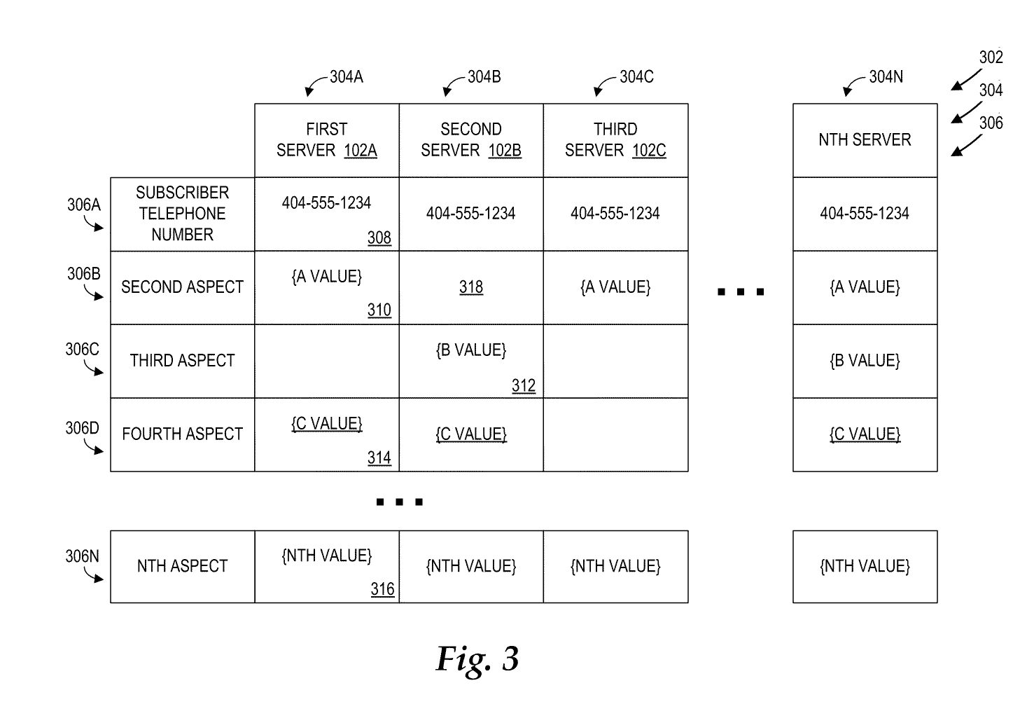

Unlike conventional implementations where the user can access the data sets 108 only through corresponding ones of the interfaces 110, the user may access the integrated data set 116 through a single interface, i.e., the data interface 118, thereby bypassing the interfaces 110. Through the data interface 118, the user can visually compare the data sets 108 within the integrated data set 116 without having to traverse between the interfaces 110. An exemplary graphical representation of the integrated data set 116 as displayed through the data interface 118 is described in greater detail below in FIG. 3.

In some embodiments, the data sets 108 may include some overlapping information. For example, in a DSL provisioning system, each of the data sets 108 may include different aspects (or facets) of individual subscriber data. However, because each DSL subscriber can be identified by telephone number, the database integration tool 114 can organize and display the data according to each subscriber's telephone number. In this way, subscribers can also be easily searched by their telephone number through the database integration tool 114.

The data interface 118 may be further configured to access and retrieve data in real-time or near real-time from the DSL equipment on the DSL network. For example, when a user views the data about DSL equipment through the data interface 118, the user may want to validate the data in real-time or near real-time. In this case, the data interface 118 may present the user with an option to access data from the DSL equipment on the DSL network in real-time or near real-time in order to validate the data displayed through the data interface 118. An example of a communication with DSL equipment on the DSL network is a port check function to a DLSAM port. Other suitable information can be retrieved from DSL equipment as contemplated by those skilled in the art.

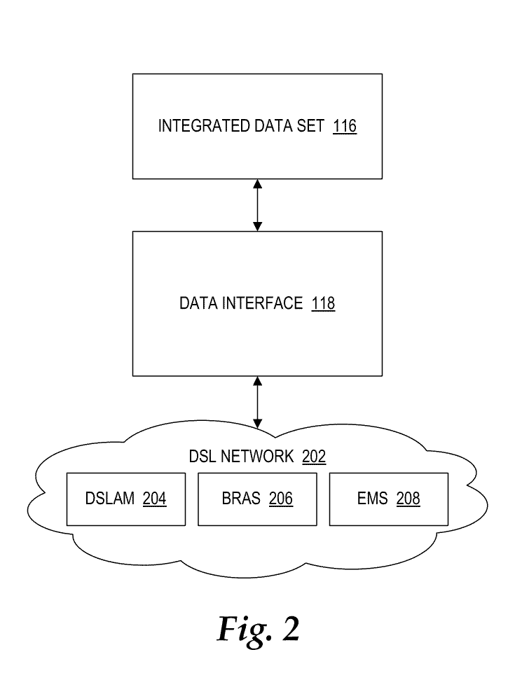

Referring now to FIG. 2, an exemplary implementation of the data interface 118 is shown, according to some embodiments. As previously described, a user may utilize the interface access module 112 to access the data interface 118. The data interface 118 may retrieve the integrated data set 116 and display the integrated data set 116. The data interface 118 may also include an option for retrieving data from a DSL network 202 in real-time or near real-time. In particular, when a user selects the option, the data interface 118 may retrieve data from DSL equipment, such as a DSLAM 204, a BRAS 206, an EMS 208, and the like, on the DSL network 202. The user may then visually verify the accuracy of the data displayed from the integrated data set 116 against the real-time or near real-time data from the DSL network 202. The type of data that can be retrieved from DSL equipment on the DSL network 202 may depend on the particular vendor platform of the DSL equipment.

Referring now to FIG. 3, an exemplary display of the data interface 118 through the interface access module 112 is shown, according to some embodiments. As illustrated in FIG. 3, the display is configured as a grid 302, which includes multiple columns 304A, 304B, 304C, 304N and multiple rows 306A, 306B, 306C, 306D, 306N. The columns 304A, 304B, 304C, 304N may be collectively referred to as columns 304. Each of the columns 304 refers to a particular one of the server computers 102. For example, the first column 304A may correspond to the first server computer 102A, and the second column 304B may correspond to the second server computer 102B. Further, the third column 304C may correspond to the third server computer 102C.

The rows 306A, 306B, 306C, 306D, 306N may be collectively referred to as rows 306. Each of the rows 306 may correspond to an aspect of subscriber data retrieved from the server computers 102. For example, as illustrated in FIG. 3, the first row 306A refers to a telephone number of a subscriber. The second row 306B, the third row 306C, and the fourth row 306D refer to additional aspects of subscriber data. These aspects of subscriber data may include any suitable information regarding the DSL subscriber and the DSL network 202.

The grid 302 includes a plurality of entries, each of which contains a value corresponding to one of the columns 304 and one of the rows 306. In one embodiment, the entries display aspects of subscriber data for a given subscriber. Thus, in this case, each of the entries should display the same values across each of the columns 304. For example, along the first row 306A, the entries, such as entry 308, display the same telephone number across each of the columns 304. Along the second row 306B, the entries, such as entry 310, display an {A value} corresponding to the second aspect of subscriber data. Along the third row 306C, the entries, such as entry 312, display a {B value} corresponding to the third aspect of subscriber data. Along the fourth row 306D, the entries, such as entry 314, display a {C value} corresponding to the fourth aspect of subscriber data. Along the Nth row 306N, the entries, such as entry 316, display a {Nth value} corresponding to the Nth aspect of subscriber data.

It should be noted that some of the entries, such as entry 318, are empty. The entry 318 may be empty because the information is not available from the server computers 102 or because the information is not found on the server computers 102. It should further be noted that some of the entries, such as the entry 314, may include a hyperlink (as indicated by an underline) to additional information. For example, the entry 314 may include a hyperlink to another webpage that displays real-time or near real-time data of DSL equipment corresponding to the entry 314 as retrieved by the data interface 118. In this way, a user can visually verify the real-time or near real-time data of DSL equipment to the data presented in the entry 314. In further embodiments, the additional information may include additional detail regarding the data presented in the entry 314.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

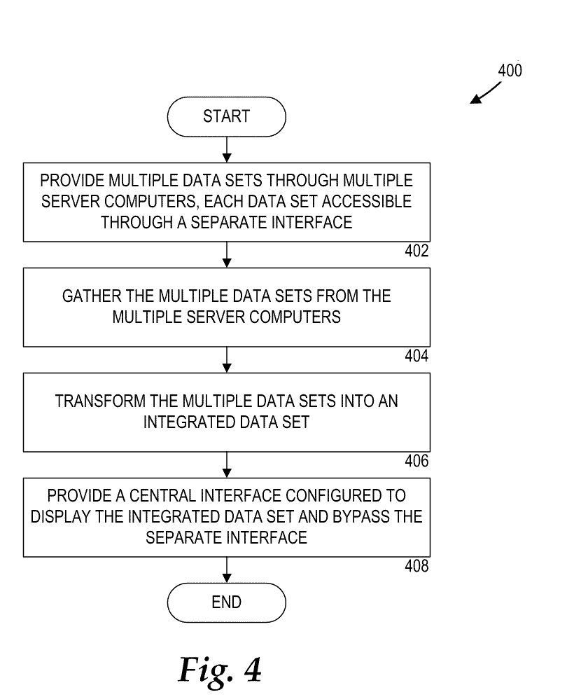

Referring now to FIG. 4, additional details will be provided regarding the operations of the database integration tool 114. In particular, FIG. 4 is a flow diagram illustrating an exemplary method 400 for generating and displaying the integrated data set 116, in accordance with some embodiments. The method 400 begins at operation 402, where multiple data sets, such as the data sets 108, are provided through multiple server computers, such as the server computers 102. Each of the server computer 102 may also provide interfaces, such as the interfaces 110, configured to access and display the data sets 108. In some embodiments, each of the interfaces 110 is configured to access and display only one of the data sets 108. For example, if the first interface 110A is configured to access and display the first data set 108A, the first interface 110A may not be configured to access and display the second data set 108B or the third data set 108C.

In some embodiments, each of the data sets 108 may include different aspects of DSL subscriber data. The data sets 108 may also include data from DSL equipment on the DSL network. The data sets 108 may further include a conversion data set and a fallout data set, which are generated when subscriber data is extracted from multiple previous databases and utilized to seed a new database. When the data sets 108 are provided through the server computers 102, the method 400 proceeds to operation 404.

At operation 404, the database integration tool 114 gathers the data sets 108 from the server computers 102. The database integration tool 114 may utilize any suitable database commands to retrieve the data sets 108 from the databases 104. The method 400 then proceeds to operation 406, where the database integration tool 114 transforms the data sets 108 into the integrated data set 116. In particular, the database integration tool 114 may merge the data sets 108 into the integrated data set 116. The method 400 then proceeds to operation 408, where the database integration tool 114 provides a central interface, such as the data interface 118, configured to access and display the integrated data set 116 in a single display.

The data interface 118 may be configured to display the different aspects of DSL subscriber data from the server computers 102 in a single interface. For example, the different aspects of DSL subscriber data may be displayed in a grid format, such as the grid 302. In this manner, a user can visually compare the different aspects of DSL subscriber data from the server computers 102 in a single view, which is more conducive to comparison and troubleshooting than conventional approaches. For example, conventional approaches may require that users access each of the data sets 108 separately through the corresponding one of the interfaces 110.

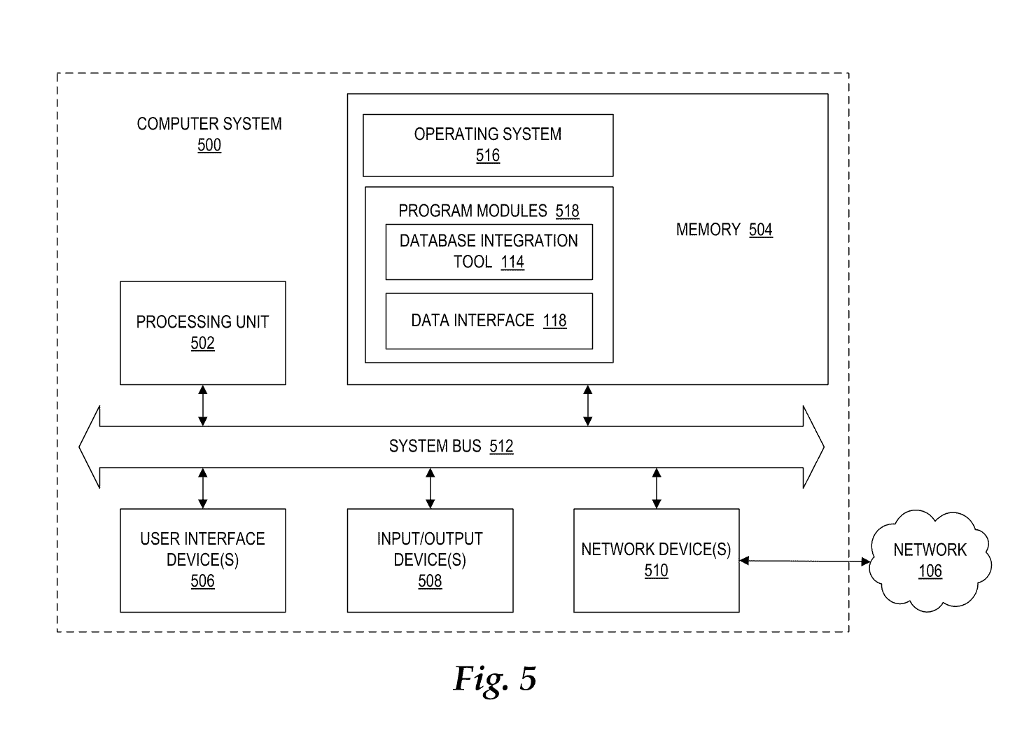

FIG. 5 and the following discussion are intended to provide a brief, general description of a suitable computing environment in which embodiments may be implemented. While embodiments will be described in the general context of program modules that execute in conjunction with an application program that runs on an operating system on a computer system, those skilled in the art will recognize that the embodiments may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

FIG. 5 is a block diagram illustrating a computer system 500 configured to generate and display the integrated data set 116, in accordance with embodiments. Examples of the computer system 500 may include the server computers 102, the merger server computer 103, and the client computer 105. The computer system 500 includes a processing unit 502, a memory 504, one or more user interface devices 506, one or more input/output (“I/O”) devices 508, and one or more network devices 510, each of which is operatively connected to a system bus 512. The bus 512 enables bi-directional communication between the processing unit 502, the memory 504, the user interface devices 506, the I/O devices 508, and the network devices 510.

The processing unit 502 may be a standard central processor that performs arithmetic and logical operations, a more specific purpose programmable logic controller (“PLC”), a programmable gate array, or other type of processor known to those skilled in the art and suitable for controlling the operation of the server computer. Processing units are well-known in the art, and therefore not described in further detail herein.

The memory 504 communicates with the processing unit 502 via the system bus 512. In one embodiment, the memory 504 is operatively connected to a memory controller (not shown) that enables communication with the processing unit 502 via the system bus 512. The memory 504 includes an operating system 516 and one or more program modules 518, according to exemplary embodiments. Examples of operating systems, such as the operating system 516, include, but are not limited to, WINDOWS, WINDOWS CE, and WINDOWS MOBILE from MICROSOFT CORPORATION, LINUX, SYMBIAN from SYMBIAN LIMITED, BREW from QUALCOMM CORPORATION, MAC OS from APPLE CORPORATION, and FREEBSD operating system. Examples of the program modules 518 include the database integration tool 114 and the data interface 118. In some embodiments, the program modules 518 are embodied in computer-readable media containing instructions that, when executed by the processing unit 502, performs the method 400 for generating and displaying the integrated data set 116, as described in greater detail above with respect to FIG. 4. According to embodiments, the program modules 518 may be embodied in hardware, software, firmware, or any combination thereof.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 500.

The user interface devices 506 may include one or more devices with which a user accesses the computer system 500. The user interface devices 506 may include, but are not limited to, computers, servers, personal digital assistants, cellular phones, or any suitable computing devices. The I/O devices 508 enable a user to interface with the program modules 518. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, or an electronic stylus. Further, the I/O devices 508 may include one or more output devices, such as, but not limited to, a display screen or a printer.

The network devices 510 enable the computer system 500 to communicate with other networks or remote systems via the network 106. Examples of the network devices 510 may include, but are not limited to, a modem, a radio frequency (“RF”) or infrared (“IR”) transceiver, a telephonic interface, a bridge, a router, or a network card. The network 106 may include a wireless network such as, but not limited to, a Wireless Local Area Network (“WLAN”) such as a WI-FL network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 106 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A computer-implemented method for displaying data from multiple server computers, the method comprising computer-implemented operations for:
gathering a first data set from a first server computer from the multiple server computers, the first server computer including a first database storing first aspects of subscriber data and a first interface configured to access the first database;
gathering a second data set from a second server computer from the multiple server computers, the second server computer including a second database storing second aspects of subscriber data and a second interface configured to access the second database;
transforming the first data set from the first server computer and the second data set from the second server computer into an integrated data set by merging the first data set and the second data set into the integrated data set; and
providing a central interface configured to access the integrated data set and bypass the first interface and the second interface, the central interface configured to concurrently display the first aspects of subscriber data and the second aspects of subscriber data through a computer.

2. The computer-implemented method of claim 1, wherein the subscriber data comprises digital subscriber line (DSL) subscriber data.

3. The computer-implemented method of claim 1, wherein the first interface is configured to access the first database and is not configured to access the second database; and wherein the second interface is configured to access the second database and is not configured to access the second database.

4. The computer-implemented method of claim 1, wherein the integrated data set includes a conversion data set and a fallout data set, the conversion data set comprises subscribers having matching data across multiple previous databases, the fallout data set comprises subscribers having non-matching data across the multiple previous databases.

5. The computer-implemented method of claim 1, wherein the central interface displays the integrated data set as a grid comprising a plurality of rows, a plurality of columns, and a plurality of entries, each of the rows corresponding to a different aspect of subscriber data, each of the columns corresponding to one of the multiple server computers, each of the entries displaying a value corresponding to one of the rows and one of the entries.

6. The computer-implemented method of claim 5, wherein the entries display values to digital subscriber line (DSL) equipment; and wherein at least one of the values comprises a hyperlink to real-time or near real-time data from the DSL equipment.

7. The computer-implemented method of claim 1, wherein the central interface enables searching of subscriber data in the integrated data set by subscriber telephone number.

8. A system for displaying data from multiple server computers, comprising:
a memory for storing a program containing code for displaying data from multiple server computers;
a processor functionally coupled to the memory, the processor being responsive to computer-executable instructions contained in the program and configured to
gather a first data set from a first server computer from the multiple server computers, the first server computer including a first database storing first aspects of subscriber data and a first interface configured to access the first database,
gather a second data set from a second server computer from the multiple server computers, the second server computer including a second database storing second aspects of subscriber data and a second interface configured to access the second database,
transform the first data set from the first server computer and the second data set from the second server computer into an integrated data set by merging the first data set and the second data set into the integrated data set, and
provide a central interface configured to access the integrated data set and bypass the first interface and the second interface, the central interface configured to concurrently display the first aspects of subscriber data and the second aspects of subscriber data through a computer.

9. The system of claim 8, wherein the subscriber data comprises digital subscriber line (DSL) subscriber data.

10. The system of claim 8, wherein the first interface is configured to access the first database and is not configured to access the second database; and wherein the second interface is configured to access the second database and is not configured to access the second database.

11. The system of claim 8, wherein the integrated data set includes a conversion data set and a fallout data set, the conversion data set comprises subscribers having matching data across multiple previous databases, the fallout data set comprises subscribers having non-matching data across the multiple previous databases.

12. The system of claim 8, wherein the central interface displays the integrated data set as a grid comprising a plurality of rows, a plurality of columns, and a plurality of entries, each of the rows corresponding to a different aspect of subscriber data, each of the columns corresponding to one of the multiple server computers, each of the entries displaying a value corresponding to one of the rows and one of the entries.

13. The system of claim 12, wherein the entries display values to digital subscriber line (DSL) equipment; and wherein at least one of the values comprises a hyperlink to real-time or near real-time data from the DSL equipment.

14. A computer-readable medium having instructions stored thereon for execution by a processor to provide a method for displaying data from multiple server computers, the method comprising:
gathering a first data set from a first server computer from the multiple server computers, the first server computer including a first database storing first aspects of subscriber data and a first interface configured to access the first database;
gathering a second data set from a second server computer from the multiple server computers, the second server computer including a second database storing second aspects of subscriber data and a second interface configured to access the second database;
transforming the first data set from the first server computer and the second data set from the second server computer into an integrated data set by merging the first data set and the second data set into the integrated data set; and
providing a central interface configured to access the integrated data set and bypass the first interface and the second interface, the central interface configured to concurrently display the first aspects of subscriber data and the second aspects of subscriber data through a computer.

15. The computer-readable medium of claim 14, wherein the subscriber data comprises digital subscriber line (DSL) subscriber data.

16. The computer-readable medium of claim 14, wherein the first interface is configured to access the first database and is not configured to access the second database; and wherein the second interface is configured to access the second database and is not configured to access the second database.

17. The computer-readable medium of claim 14, wherein the integrated data set includes a conversion data set and a fallout data set, the conversion data set comprises subscribers having matching data across multiple previous databases, the fallout data set comprises subscribers having non-matching data across the multiple previous databases.

18. The computer-readable medium of claim 14, wherein the central interface displays the integrated data set as a grid comprising a plurality of rows, a plurality of columns, and a plurality of entries, each of the rows corresponding to a different aspect of subscriber data, each of the columns corresponding to one of the multiple server computers, each of the entries displaying a value corresponding to one of the rows and one of the entries.

19. The computer-readable medium of claim 18, wherein the entries display values to digital subscriber line (DSL) equipment; and wherein at least one of the values comprises a hyperlink to real-time or near real-time data from the DSL equipment.

20. The computer-readable medium of claim 14, wherein the central interface enables searching of subscriber data in the integrated data set by subscriber telephone number.
